(19) United States
(12) Patent Application Publication
(10) Pub. No.: US 2020/0229394 A1
(43) Pub. Date: Jul. 23, 2020

(54) ANIMAL FEEDING APPARATUS

(71) Applicant: Tony Michael Campo, Key West, FL (US)

(72) Inventor: Tony Michael Campo, Key West, FL (US)

(21) Appl. No.: 16/745,624

(22) Filed: Jan. 17, 2020

Related U.S. Application Data
(60) Provisional application No. 62/793,421, filed on Jan. 17, 2019.

(51) Int. Cl. A01K 5/00

(52) U.S. Cl. CPC A01K 5/002

(57) ABSTRACT

An animal feeding apparatus includes a drum having a longitudinal axis, the drum having a center of gravity below the longitudinal axis, the apparatus comprising a perforated section arrayed parallel to the longitudinal axis of the drum so that feed contained in the drum can pass through the perforations of the perforated section when the drum is pushed by an animal to cause the drum to rock back and forth along the longitudinal axis of the drum.

### CROSS-REFERENCE TO RELATED APPLICATION

This application claims the benefit of U.S. Provisional Application No. 62/793,421, filed Jan. 17, 2019, and which is hereby incorporated by reference in its entirety.

### TECHNICAL FIELD

This disclosure relates to devices configured to dispense animal feed.

### BACKGROUND

Feeders for use by hunters of feral hogs and other animals are commercially available. However, with prior art feeders, feral hogs easily learn how to dispense the feed from the hopper in a relatively short time and often eat all the feed before a hunter discovers the event. Some feeders use electric motors to dispense a controlled amount of feed at controlled times but suffer from battery or other electrical failures.

### SUMMARY

An animal feeding apparatus having significant feed capacity, controlled feed dispensing rate and simple reliability is provided. More specifically, the animal feeding apparatus includes a drum having a longitudinal axis, the drum having a center of gravity below the longitudinal axis, the apparatus comprising a perforated section arrayed parallel to the longitudinal axis of the drum so that feed contained in the drum can pass through the perforations of the perforated section when the drum is pushed by an animal to cause the drum to rock back and forth along the longitudinal axis of the drum.

The animal feeding apparatus improves upon the prior art by providing a controlled feed dispensing rate with simple reliability.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, perspective view of animal feeding apparatus comprising a drum shaped main body resting on the ground;

FIG. 2 is a schematic, sectional, end view of the embodiment shown in FIG. 1;

FIG. 3 is a schematic, cross-sectional view of a portion of the main body;

FIG. 4 is a schematic, bottom view of a spout of the feeding apparatus;

FIG. 5 is a schematic, sectional, end view an alternative embodiment of the animal feeding apparatus;

FIG. 6 is a schematic, top view of the embodiment shown in FIG. 5;

FIG. 7 is a schematic, side view of the embodiment shown in FIG. 5;

FIG. 8 is a schematic, sectional, end view of the embodiment shown in FIG. 5;

FIG. 9 is a schematic, cross-sectional view of a portion of the main body of the embodiment of FIG. 5; and

FIG. 10 is a schematic, cross-sectional side view of the embodiment of FIG. 5.

### DESCRIPTION OF THE PREFERRED EMBODIMENTS

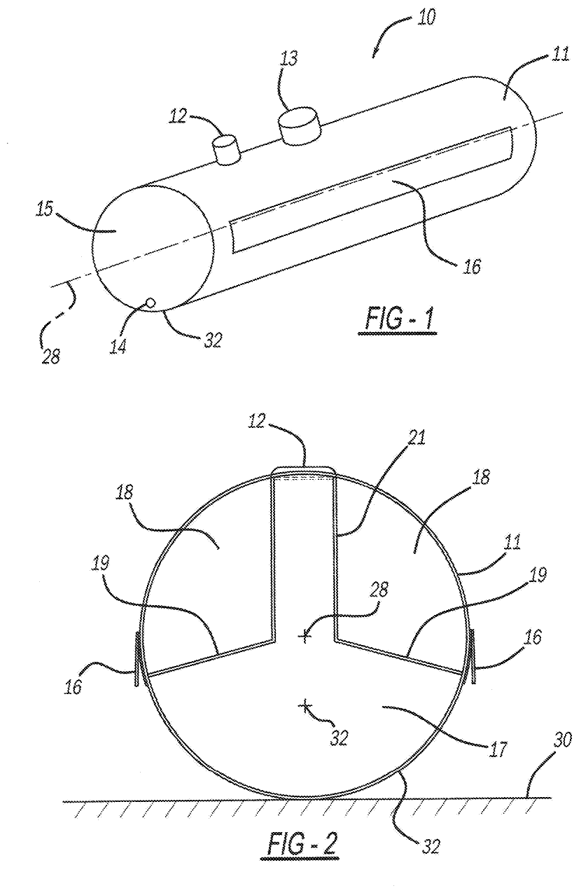

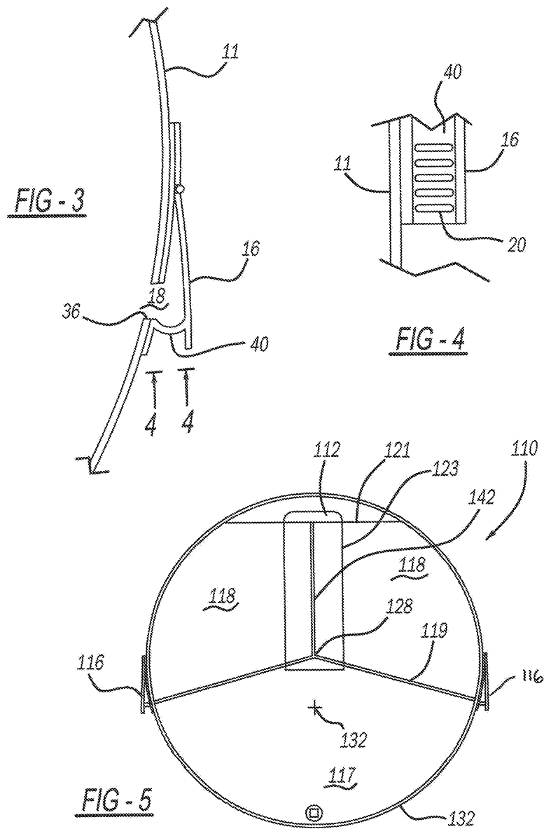

FIGS. 1-4, wherein like reference numbers refer to like components, schematically depict an animal feeding apparatus 10. Referring specifically to FIG. 1, the apparatus 10 is comprised of tubular or cylindrical shell 11 (also sometimes referred to herein as a “drum” or “container”), end 15 having drain plug 14, water inlet 12, corn inlet 13 and corn release door 16. Referring now to FIG. 2, therein is shown an end interior view of the apparatus 10 comprised of shell 11, water inlet 12 and corn release doors 16. Partition 19 partitions the interior of shell 11 into a lower water chamber 17 and an upper corn chamber 18. A tube 21 provides fluid communication from the lower water chamber 17 to the water inlet 12. The view shown in FIG. 2 includes a tubular section of the partition for filling the water chamber 17 with water. Another tubular section (not shown) of the partition is provided for filling the corn chamber 18 with corn. Referring now to FIG. 3, therein is shown details of perforations 20 of the perforated sections of the embodiment shown in FIG. 2.

Referring to FIGS. 1-3, in use the water chamber 17 is filled with water, the corn chamber 18 is filled with corn and the perforations of the perforated section are sized so that corn does not flow from the feeder when the feeder is at rest but so that corn will flow from the feeder when the feeder is pushed back and forth by an animal so that the feeder rocks back and forth along the longitudinal axis of the feeder.

More specifically, the water in the lower water chamber 17 is denser than the corn, thereby ensuring that the center of gravity 24 of the apparatus 10 is below the longitudinal axis 28 of the cylindrical shell 11. Accordingly, when the shell 11 is on the ground 30 or other surface, the curved lower surface 32 of the shell 11 contacts the ground 30. The position of the center of gravity 24 ensures that the apparatus 10, after rocking or rolling on surface 32, automatically returns to the upright position shown in the Figures.

Accordingly, when a feral hog or other animal nudges the apparatus 10 to induce a rocking or rolling motion of the apparatus, the center of gravity being offset from the axis of rotation encourages a rocking motion rather than a continuous rolling motion. The rocking motion agitates the corn in the corn chamber 18, which causes some of the corn 18 to exit the chamber 18 through the perforations 20. In the absence of this agitation, the corn 18 remains in the chamber. Accordingly, the corn or other feed in the chamber 18 is dispensed only when the animal is present to induce the rocking motion.

Referring specifically to FIGS. 3 and 4, the shell 11 defines a hole 36 from the corn chamber 18, which leads to the corn release door 16. The lower surface 40 of the corn release door 16 defines a plurality of perforations 20, i.e., holes or apertures, through which the corn is dispensed.

Referring again to FIG. 1, the drain plug 14 enables the water to be drained from the water chamber 17 to reduce the weight of the apparatus 10, such as for transportation and storage when not in use.

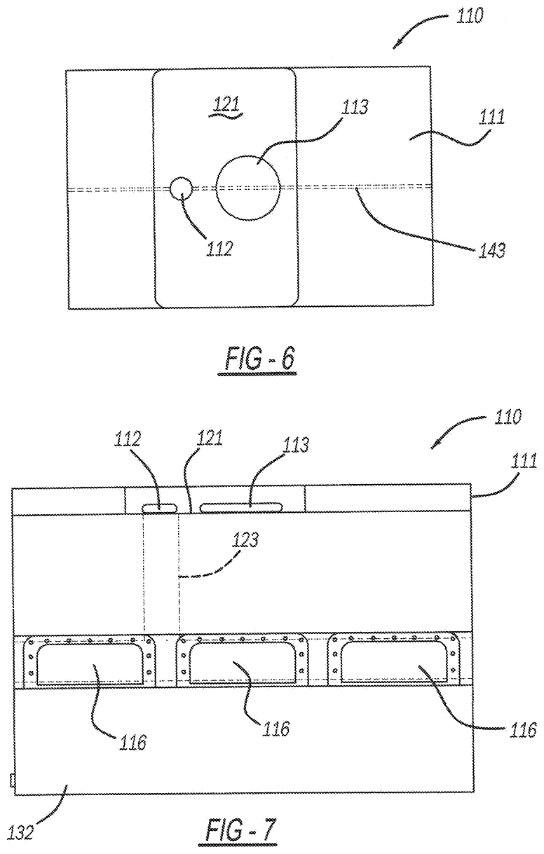

FIGS. 5-9, wherein like reference numbers refer to like components, schematically depict an alternative animal feeding apparatus 110. Referring now to FIGS. 4-8, the apparatus 110 includes a cylindrical shell or container 111, which, in the embodiment depicted is a 30 gallon high density polyethylene drum. The water inlet 112 and corn fill inlet 113 are recessed as shown. More specifically, the outer surface of the container 111 defines a recess 121 in the otherwise cylindrical outer surface. A partition 19 partitions the interior of shell 11 into a lower water chamber 117 and an upper corn chamber 118. A tube 123 provides fluid communication from the water inlet 112 to the lower water chamber 117. The corn chamber 118 is partitioned by a divider plate 142, which helps maintain the center of gravity of the feeding apparatus 110 by preventing excessive shifting of corn in the corn compartment 118 when the feeding apparatus 110 is bumped. The corn release perforations shown in FIG. 7 are highly preferred.

In use the water chamber 117 is filled with water (shown at 150 in FIG. 9), the corn chamber 18 is filled with corn or other granular animal feed (shown at 154 in FIG. 9) and the perforations 120 of the perforated section are sized so that corn does not flow from the feeder when the feeder is at rest but so that corn will flow from the feeder when the feeder is pushed back and forth by an animal so that the feeder rocks back and forth along the longitudinal axis of the feeder.

More specifically, the water in the lower water chamber 117 is denser than the corn, thereby ensuring that the center of gravity 124 of the apparatus 110 is below the longitudinal axis 128 of the cylindrical shell 111. Accordingly, when the shell 11 is on the ground or other surface, the curved lower surface 132 of the shell 11 contacts the ground. The position of the center of gravity 124 ensures that the apparatus 110, after rocking or rolling on surface 132, automatically returns to the upright position shown in the Figures.

Accordingly, when a feral hog or other animal nudges the apparatus 110 to induce a rocking or rolling motion of the apparatus, the center of gravity being offset from the axis of rotation encourages a rocking motion rather than a continuous rolling motion. The rocking motion agitates the corn in the corn chamber 118, which causes some of the corn 154 to exit the chamber 118 through the perforations 120. In the absence of this agitation, the corn 154 remains in the chamber 118. Accordingly, the corn or other feed in the chamber 118 is dispensed only when an animal is present to induce the rocking motion.

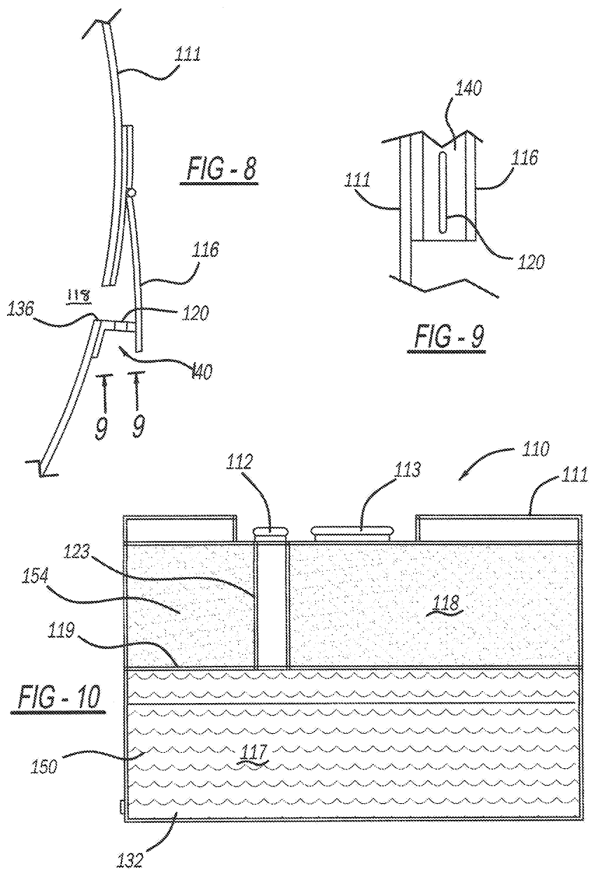

Referring specifically to FIGS. 7 and 8, the shell 111 defines a hole 136 from the corn chamber 118, which leads to the corn release door 116. The lower surface 140 of the corn release door 116 defines a plurality of perforations 120, i.e., holes or apertures, through which the corn is dispensed.

The apparatus of the instant invention can be made of any suitable material. The feed used is preferably corn but any granulated feed can be used as long as the perforations are sized so that feed contained in the drum will not pass through the perforations when the apparatus is a rest but will pass through the perforations of the perforated section when the apparatus is pushed by an animal to cause it to rock back and forth along the longitudinal axis of the apparatus. There are many alternative embodiments of the apparatus of the instant invention. For example, a 30 or 55 gallon steel drum having a removable lid can be used in the instant invention by placing relatively heavy objects such as bricks or stones or a water bladder in a drum laid on the ground provided the drum is also provided with the feed dispensing perforations. It is also contemplated that the apparatus of the instant invention could comprise an extruded thermoplastic center portion having thermoplastic end portions joined thereto.

An important benefit of the instant invention is its simplicity and reliability. The instant invention can be transported to a hunting site and then weighted with, for example and without limitation thereto, water, sand, stones, bricks, or blocks and filled with feed. The number and size of the perforations of the instant invention can be optimized to control the amount of feed dispensed when the feeder is pushed by an animal. The instant invention is especially suitable for use when hunting feral hogs.

While the best modes for carrying out the invention have been described in detail, those familiar with the art to which this invention relates will recognize various alternative designs and embodiments for practicing the invention within the scope of the appended claims.

1. An apparatus for dispensing feed to animals, comprising:
a drum having a longitudinal axis, the drum having a center of gravity below the longitudinal axis;
the apparatus having a perforated section arrayed parallel to the longitudinal axis of the drum so that feed contained in the drum can pass through the perforations of the perforated section when the drum is pushed by an animal to cause the drum to rock back and forth along the longitudinal axis of the drum.

2. The apparatus of claim 1, further comprising matter positioned within the drum so that the center of gravity of the drum is below the longitudinal axis of the drum.

3. The apparatus of claim 1, wherein the drum is partitioned into a lower chamber and an upper chamber so that the lower chamber.

4. The apparatus of claim 3, further comprising grain in the upper chamber and water in the lower chamber.

5. The apparatus of claim 3, wherein the upper chamber is partitioned along the longitudinal axis of the drum.

6. The apparatus of claim 5, wherein the drum comprises an extruded thermoplastic center portion having thermoplastic end portions joined thereto.

7. An animal feeding apparatus comprising:
a container defining a first chamber and a plurality of perforations extending from the first chamber to the exterior of the container; and
a curved surface being substantially rigidly connected to the container.

8. The animal feeding apparatus of claim 7, wherein the container is cylindrical having a longitudinal axis; and
wherein the curved surface is a portion of the outer surface of the container.

9. The animal feeding apparatus of claim 8, wherein the container has a center of gravity that is below the longitudinal axis.

10. The animal feeding apparatus, wherein the container defines a second chamber below the first chamber.

11. The animal feeding apparatus of claim wherein the perforations are sized such and positioned such that, when corn is contained within the first chamber, the corn passes through the perforations only as a result of agitation of the corn.

12. The animal feeding apparatus of claim 11, wherein said agitation of the corn is caused by the rotation of the container about the longitudinal axis.

13. A method comprising:
obtaining an animal feeding apparatus having container, the container defining a first chamber and a plurality of perforations extending from the first chamber to the exterior of the container, and a curved surface being substantially rigidly connected to the container;
placing animal feed in the first chamber;
placing the curved surface on the ground or other surface so that the container is rockable about an axis; and
wherein the center of gravity of the apparatus and animal feed is below the axis.

14. The method of claim 13, futher comprising adding matter to the apparatus to change the center of gravity of the apparatus and feed so that the center of gravity is below the axis.

15. The method of claim 14, wherein the container defines a second chamber separate from the first chamber; and
wherein said adding matter to the apparatus includes adding matter to the second chamber.

16. The method of claim 15, wherein said matter is a liquid.

17. The method of claim 16, wherein said liquid is water.
